(19) United States
(12) Patent Application Publication
(10) Pub. No.: US 2026/0185905 A1
(43) Pub. Date: Jul. 2, 2026

(54) FLUID CONTROL APPARATUS, DIAGNOSTIC PROGRAM FOR A FLUID CONTROL APPARATUS, AND DIAGNOSTIC METHOD FOR A FLUID CONTROL APPARATUS

(71) Applicant: HORIBA STEC, Co., Ltd., Kyoto-shi (JP)

(72) Inventors: Kazuya TOKUNAGA, Kyoto-shi (JP); Seiji HIGUCHI, Kyoto-shi (JP); Daisuke HAYASHI, Kyoto-shi (JP); Kotaro TAKIJIRI, Kyoto-shi (JP)

(21) Appl. No.: 19/418,540

(22) Filed: Dec. 12, 2025

(30) Foreign Application Priority Data
Dec. 26, 2024 (JP) 2024-229984

(51) Int. Cl. G01M 99/00; G05D 7/06

(52) U.S. Cl. CPC G01M 99/008; G05D 7/0623

(57) ABSTRACT

A fluid control apparatus 100 is provided with a second flow rate calculation unit 431 that calculates a flow rate flowing through a fluid resistor 33 based on a change over time in an upstream-side pressure P1 or a downstream-side pressure P2 in a state in which a fluid control valve 32 is closed, and with a diagnostic parameter calculation unit 432 that calculates a diagnostic parameter based on a first flow rate calculated by a first flow rate calculation unit 431, and on a second flow rate calculated by the second flow rate calculation unit 432 in a state in which the fluid control valve 32 is closed.

### CROSS-REFERENCE TO RELATED APPLICATION(S)

The present application claims priority to Japanese Patent Application No. 2024-229984 filed Dec. 26, 2024, which is incorporated herein by reference in its entirety.

### BACKGROUND OF THE INVENTION

### Technical Field

The present invention relates to a fluid control apparatus, a diagnostic program for a fluid control apparatus, and a diagnostic method for a fluid control apparatus.

### Description of the Related Art

As is shown, for example, in Patent Document 1, conventional fluid control apparatuses are equipped with a fluid resistor that is provided on a flow path, a downstream-side valve that is provided on a downstream side of the fluid resistor, an upstream-side pressure sensor that detects a pressure on an upstream side of the fluid resistor, and a downstream-side pressure sensor that detects a downstream-side pressure which is a pressure between the fluid resistor and the downstream-side valve.

In this type of fluid control apparatus, a first flow rate, which is the flow rate flowing through the fluid resistor, is calculated based on the upstream-side pressure and the downstream-side pressure, and a second flow rate, which is the flow rate flowing out from the downstream-side valve, is calculated based on the first flow rate and on an equivalent flow rate that is calculated from a change over time in the downstream-side pressure. In addition, a diagnostic unit that is provided in this type of fluid control apparatus diagnoses whether or not any abnormalities are present in the fluid control apparatus by comparing the first flow rate with the second flow rate in a state in which the downstream-side valve has been closed.

### PRIOR ART DOCUMENT

### Patent Document

Patent Document 1: Japanese Patent Application Laid-Open No. 2019-028747

### SUMMARY OF THE INVENTION

Here, the type of abnormalities that might occur in the above-described fluid control apparatus include abnormalities in the fluid resistor, abnormalities in the fluid control valve, and/or abnormalities in the pressure sensors and the like. However, in this fluid control apparatus, although the diagnostic unit is able to diagnose whether or not an abnormality is present in the fluid control apparatus, it is not able to diagnose which of the devices constituting the fluid control apparatus an abnormality is occurring in.

In particular, in the above-described fluid control apparatus, it is not possible to diagnose whether an abnormality in the fluid control apparatus is an abnormality in the fluid resistor, and it is not possible to quantitatively calculate the abnormality in the flow rate resistance. Furthermore, in a case in which there is an abnormality in the fluid resistor, modifying a correction coefficient used in calculating the flow rate in accordance with the abnormality in the flow rate resistance may be considered, however, because it is not possible to diagnose whether or not there is an abnormality in the fluid resistor, it is not possible to modify the correction coefficient in accordance with the abnormality in the flow rate resistance.

The present invention was, therefore, conceived in order to solve the above-described problem, and it is a principal object thereof to make it possible to determine whether or not an abnormality in a fluid control apparatus is an abnormality in the fluid resistor, and to enable an abnormality in the flow rate resistance to be quantitatively calculated.

In other words, a fluid control apparatus according to the present invention is characterized in being provided with a fluid resistor that is provided on a flow path, an upstream-side pressure sensor that detects a pressure on an upstream side of the fluid resistor, a downstream-side pressure sensor that detects a pressure on a downstream side of the fluid resistor, a first flow rate calculation unit that calculates a flow rate flowing through the fluid resistor based on the upstream-side pressure and the downstream-side pressure, a fluid control valve that is provided on an upstream-side of the upstream-side pressure sensor or on a downstream-side of the downstream-side pressure sensor, a valve control unit that controls the fluid control valve based on the first flow rate, a second flow rate calculation unit that calculates a flow rate flowing through the fluid resistor based on a change over time in the upstream-side pressure or the downstream-side pressure in a state in which the fluid control valve is closed, and a diagnostic parameter calculation unit that calculates a diagnostic parameter based on the first flow rate calculated by the first flow rate calculation unit, and on the second flow rate calculated by the second flow rate calculation unit in a state in which the fluid control valve is closed.

If this type of fluid control apparatus is employed, then it is possible to diagnose an abnormality in a fluid resistor using a diagnostic parameter calculated based on two flow rates, namely, a first flow rate and a second flow rate, that are calculated from a flow rate flowing through a fluid resistor in a state in which the fluid control valve is closed.

Moreover, in a case in which there is an abnormality in the fluid resistor, because this abnormality in the fluid resistor can be quantitatively determined based on the diagnostic parameter, it is possible to modify a correction coefficient used in the flow rate calculation of the first flow rate calculation unit.

It is also possible to employ a structure in which there is further provided a diagnostic unit that diagnoses an abnormality in the fluid resistor based on the diagnostic parameter, and/or modifies a correction coefficient used in the flow rate calculation by the first flow rate calculation unit.

If this type of structure is employed, then because the diagnostic unit diagnoses an abnormality in a fluid resistor based on a diagnostic parameter, the diagnostic unit is able to not only diagnose whether or not an abnormality is present in the fluid resistor, but is also able to diagnose the extent or type of abnormality in the fluid resistor based on the diagnostic parameter.

Moreover, because the diagnostic unit modifies the correction coefficient used in the flow rate calculation by the first flow rate calculation unit, even in a case in which the diagnostic parameter has changed compared to a normal fluid resistor, the first flow rate calculation unit is able to accurately calculate the first flow rate based on the modified correction coefficient.

It is also possible to employ a structure in which the diagnostic unit diagnoses an abnormality in the fluid resistor based on a value of the diagnostic parameter at any point during a predetermined period after the fluid control valve was closed, or modifies a correction coefficient used in the flow rate calculation by the first flow rate calculation unit.

If this type of structure is employed, then the diagnostic unit is able to diagnose whether an abnormality in the fluid control apparatus is an abnormality in the fluid resistor, or is an abnormality in a device other than the fluid resistor, based on the value of the diagnostic parameter at any point during a predetermined period after the fluid control valve was closed.

The main types of abnormalities in a fluid resistor are a blockage in the fluid resistor, which is an abnormality in which it is more difficult for a fluid to flow through the fluid resistor than at the time of calibration, and a leak in the fluid resistor, which is an abnormality in which the fluid flows more excessively through the fluid resistor than at the time of calibration.

For this reason, it is also possible to employ a structure in which the diagnostic unit distinguishes between a blockage and a leak in the fluid resistor based on the value of the diagnostic parameter.

If this type of structure is employed, then it is possible for the diagnostic unit to determine the type of abnormality in the fluid resistor.

It is also possible to employ a structure in which the diagnostic unit diagnoses an abnormality in a fluid device other than the fluid resistor based on a change over time in the diagnostic parameter.

If this type of structure is employed, then it is possible to determine whether an abnormality is an abnormality in a fluid device other than a fluid resistor based on a change over time in a diagnostic parameter. More specifically, if a change over time in a diagnostic parameter is within a predetermined range, the diagnostic unit is able to diagnose that there is an abnormality in the fluid resistor, and if the change over time in the diagnostic parameter is outside the predetermined range, the diagnostic unit is able to diagnose that there is an abnormality in the fluid control valve or in the respective pressure sensors.

It is also possible to employ a structure in which the diagnostic unit diagnoses that there is an abnormality in the fluid control valve and/or an abnormality in each of the pressure sensors after diagnosing that there is an abnormality in the fluid resistor and/or after modifying the correction coefficient.

If this type of structure is employed, then because the diagnostic unit diagnoses abnormalities in the fluid control valve and/or in each pressure sensor in addition to diagnosing an abnormality in the fluid resistor, it is possible to diagnose which of the devices forming the fluid control apparatus is abnormal when an abnormality in the fluid control apparatus is detected.

It is also possible to employ a structure in which the diagnostic parameter is a ratio between the first flow rate and the second flow rate, or is a value determined using this ratio.

If this type of structure is employed, then it becomes possible not only to diagnose whether or not there is an abnormality in the fluid resistor, but also to determine the type and extent of the abnormality in the fluid resistor.

Moreover, a diagnostic program for a fluid control apparatus according to the present invention is a diagnostic program for a fluid control apparatus that is provided with a fluid resistor that is provided on a flow path, an upstream-side pressure sensor that detects a pressure on an upstream side of the fluid resistor, a downstream-side pressure sensor that detects a pressure on a downstream side of the fluid resistor, a first flow rate calculation unit that calculates a first flow rate flowing through the fluid resistor based on the upstream-side pressure and the downstream-side pressure, a fluid control valve that is provided on an upstream side of the upstream-side pressure sensor or on a downstream side of the downstream-side pressure sensor, and a valve control unit that controls the fluid control valve based on the first flow rate, and is characterized by enabling a computer to function as a second flow rate calculation unit that calculates a second flow rate flowing through the fluid resistor based on a change over time in the upstream-side pressure or the downstream-side pressure in a state in which the fluid control valve is closed, and as a diagnostic parameter calculation unit that calculates a diagnostic parameter based on the first flow rate calculated by the first flow rate calculation unit, and on the second flow rate calculated by the second flow rate calculation unit in a state in which the fluid control valve is closed.

Furthermore, a diagnostic method for a fluid control apparatus according to the present invention is a diagnostic method for a fluid control apparatus that is provided with a fluid resistor that is provided on a flow path, an upstream-side pressure sensor that detects a pressure on an upstream side of the fluid resistor, a downstream-side pressure sensor that detects a pressure on a downstream side of the fluid resistor, a first flow rate calculation unit that calculates a flow rate flowing through the fluid resistor based on the upstream-side pressure and the downstream-side pressure, a fluid control valve that is provided on an upstream side of the upstream-side pressure sensor or on a downstream side of the downstream-side pressure sensor, and a valve control unit that controls the fluid control valve based on the first flow rate, and is characterized in that a flow rate flowing through the fluid resistor is calculated based on a change over time in the upstream-side pressure or the downstream-side pressure in a state in which the fluid control valve is closed, and a diagnostic parameter is calculated based on the first flow rate calculated by the first flow rate calculation unit and on the second flow rate in a state in which the fluid control valve is closed.

According to the present invention that is formed in the above-described manner, it is possible to diagnose whether or not an abnormality in a fluid control apparatus is an abnormality in a fluid resistor, and to quantitatively calculate an abnormality in a fluid resistor.

### BRIEF DESCRIPTION OF THE DRAWINGS

FIG. 1 is a schematic view showing a fluid control apparatus according to an embodiment of the present invention;

FIG. 2 is a graph showing a change over time in a diagnostic parameter of the same embodiment;

FIG. 3 contains (a) a graph showing a valve leak pressure change model, a sensor shift pressure change model, and changes over time in an upstream-side pressure in a case in which an abnormality occurs in the fluid control valve of the same embodiment, and (b) a graph showing a valve leak pressure change model, a sensor shift pressure change model, and changes over time in an upstream-side pressure in a case in which an abnormality occurs in a pressure sensor of the same embodiment;

FIG. 4 contains (a) a graph showing changes over time in a valve leak difference and changes over time in a sensor shift difference in a case in which an abnormality occurs in the fluid control valve of the same embodiment, and (b) a graph showing changes over time in a valve leak difference and changes over time in a sensor shift difference in a case in which an abnormality occurs in the pressure sensor of the same embodiment;

FIG. 5 is a flowchart showing a diagnostic method of the fluid control apparatus of the same embodiment;

FIG. 6 is a graph showing a case in which a Fourier transform is performed on a valve leak difference and a sensor leak difference in a case in which an abnormality occurs in a pressure sensor in a variant embodiment; and

FIG. 7 is a graph showing a case in which a low-pass filter is applied to a valve leak difference in a case in which an abnormality occurs in the pressure sensor, and a case in which a low-pass filter is applied to a sensor leak difference in a case in which an abnormality occurs in the pressure sensor in a variant embodiment.

### DETAILED DESCRIPTION

Hereinafter, an embodiment of a fluid control apparatus according to the present invention will be described with reference to the drawings. Note that, in order to simplify an understanding thereof, each of the drawings depicted below is shown schematically with omissions or enhancements made where these have been deemed appropriate. In addition, component elements that are the same in the respective drawings are indicated by the same descriptive symbols and any duplicated description thereof is omitted.

A fluid control apparatus 100 of the present embodiment is used, for example, in a semiconductor manufacturing process or the like, and is provided on one or more gas supply lines in order to control a flow rate of a processing gas flowing through each gas supply line.

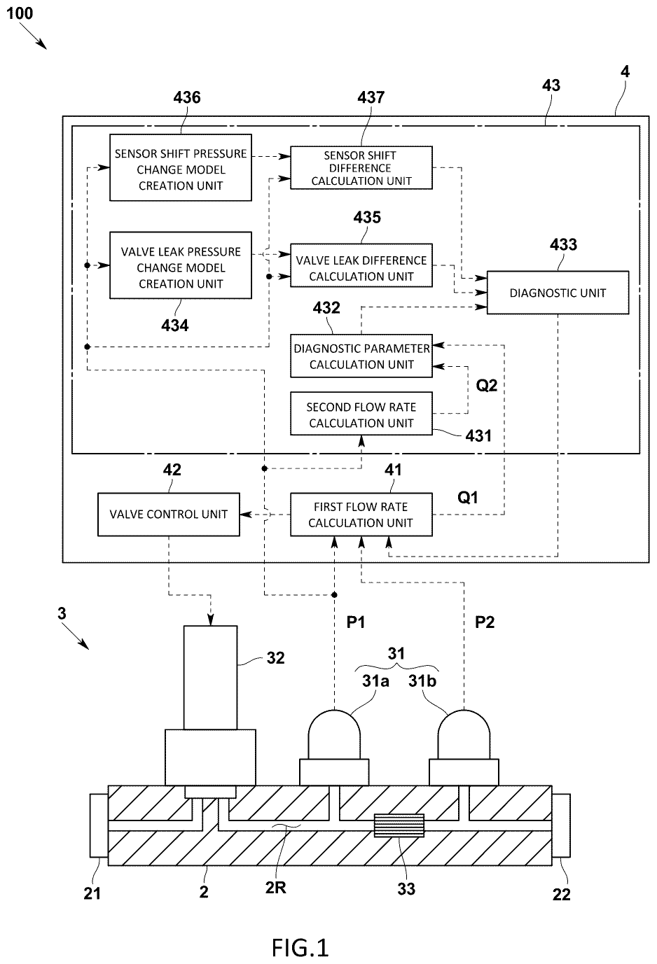

More specifically, the fluid control apparatus 100 is what is known as a differential pressure mass flow controller (i.e., a differential pressure MFC) and, as shown in FIG. 1, is provided with a flow path block 2 in which are formed a plurality of internal flow paths 2R, a fluid control device 3 that is provided in the flow path block 2, and a calculation control device 4 that controls the fluid control device 3 and performs various types of calculations.

The flow path block 2 is provided with an intake port 21 through which a fluid is introduced into the internal flow path 2R, and a discharge port 22 through which a fluid is discharged from the internal flow path 2R. An upstream-side pipe (not shown in the drawings) is connected to the intake port 21, and an upstream-side air pressure valve (not shown in the drawings) is provided on this upstream-side pipe. A downstream-side pipe (not shown in the drawings) is connected to the discharge port 22, and a downstream-side air pressure valve (not shown in the drawings) is provided on the downstream-side pipe.

The fluid control device 3 controls the fluid in the internal flow path 2R, and includes a flow rate sensor 31 that measures a flow rate of the fluid flowing through the internal flow path 2R, and a fluid control valve 32 that is provided on the upstream side of the flow rate sensor 31.

The flow rate sensor 31 is a differential pressure type of flow rate sensor and includes an upstream-side pressure sensor 31a that is provided on the upstream side of a fluid resistor 33 provided on the internal flow path 2R, and a downstream-side pressure sensor 31b that is provided on the downstream side of the fluid resistor 33. A flow rate flowing through the internal flow path 2R is calculated using a pressure P1 on the upstream side of the fluid resistor 33 detected by the upstream-side pressure sensor 31a, and a pressure P2 on the downstream side of the fluid resistor 33 detected by the downstream-side pressure sensor 31b. Note that the fluid resistor 33 may be, for example, a restrictor, an orifice, a nozzle, a Venturi tube, and/or a capillary tube or the like.

The fluid control valve 32 is provided on the upstream side of the flow rate sensor 31. More specifically, the fluid control valve 32 controls the flow rate by causing a valve body to move forwards and backwards relative to a valve seat using a piezoelectric actuator. Note that the valve opening of the fluid control valve 32 is controlled via feedback control performed by a valve control unit 42 of the calculation control device 4 (described below). In the present embodiment, the fluid control valve 32 is provided on the upstream side of the upstream-side pressure sensor 31a, but may also be provided on the downstream side of the downstream-side pressure sensor 31b.

The calculation control device 4 is what is known as a computer that is equipped, for example, with a CPU, memory, A/D and D/A converters, and input/output means. As is shown in FIG. 1, as a result of a program stored in the memory being executed so that the various devices operate in mutual collaboration, the calculation control device 4 performs the functions of at least a first flow rate calculation unit 41, a valve control unit 42, and a diagnostic mechanism 43. Note that, in the present embodiment, the calculation control device 4 is housed within a casing that houses the fluid control device 3, but it is also possible for the calculation control device 4 to be provided outside the casing. It is also possible for just the diagnostic mechanism 43 alone to be provided outside the casing.

Hereinafter, each of the portions constituting the calculation control device 4 will be described.

The first flow rate calculation unit 41 calculates a flow rate (i.e., a first flow rate Q1) flowing through the fluid resistor based on the upstream-side pressure P1 and the downstream-side pressure P2. More specifically, the first flow rate calculation unit 41 calculates a differential pressure ΔP between the upstream-side pressure P1 and the downstream-side pressure P2, and calculates the first flow rate Q1 by multiplying the differential pressure ΔP by a predetermined coefficient. At this time, it is assumed that a predetermined fluid is flowing through the fluid resistor 33.

The valve control unit 42 controls the fluid control valve 32 based on the first flow rate Q1. In the present embodiment, the valve control unit 42 controls the valve opening of the fluid control valve 32 based on the first flow rate Q1.

The diagnostic mechanism 43 diagnoses abnormalities in the fluid resistor 33, the fluid control valve 32, and/or the respective pressure sensors 31a and 31b in a state in which the fluid control valve 32 is closed.

More specifically, as shown in FIG. 1, the diagnostic mechanism 43 includes a second flow rate calculation unit 431, a diagnostic parameter calculation unit 432, a diagnostic unit 433, a valve leak pressure change model creation unit 434, a valve leak difference calculation unit 435, a sensor shift pressure change model creation unit 436, and a sensor shift difference calculation unit 437.

In the present embodiment, the diagnostic mechanism 43 diagnoses abnormalities in the fluid resistor 33 in a state in which the fluid control valve 32 is closed, and thereafter diagnoses abnormalities in the fluid control valve 32 and/or the respective pressure sensors 31a and 31b. Hereinafter, of the functional portions constituting the diagnostic mechanism 43, the functional portion that diagnoses an abnormality in the fluid resistor 33 will be described.

The second flow rate calculation unit 431 calculates a flow rate (i.e., a second flow rate Q2) flowing through the fluid resistor based on a change over time in the upstream-side pressure P1 in a state in which the fluid control valve 32 is closed. More specifically, the second flow rate Q2 is a flow rate obtained by performing a time differentiation on a gas equation of state that has been solved for the upstream-side pressure P1 in a state in which the fluid control valve 32 is closed. Even more specifically, the second flow rate Q2 is expressed as a product of at least a time differentiation performed on a gas equation of state that has been solved for the upstream-side pressure P1 and an internal volume. Here, ‘internal volume’ refers to a space in the internal flow path 2R from a valve seat surface of the fluid control valve 32 to an upstream-side end portion of the fluid resistor 33. Note that the change over time in the upstream-side pressure P1 when calculating the second flow rate Q2 is not limited to a value obtained by differentiation, and may instead be, for example, a difference value between the upstream-side pressure P1 at two points in time after the fluid control valve 32 has been closed or the like.

The diagnostic parameter calculation unit 432 calculates a diagnostic parameter based on the first flow rate Q1 that was calculated by the first flow rate calculation unit 41, and on the second flow rate Q2 that was calculated by the second flow rate calculation unit 431 in a state in which the fluid control valve 32 was closed. The diagnostic parameter is a value determined using a ratio between the first flow rate Q1 and the second flow rate Q2. More specifically, the diagnostic parameter is expressed by the following Equation 1. The term ‘a state in which the fluid control valve 32 is closed’ refers here to a state in which the fluid control valve 32 is closed after a state in which a fluid has been flowing through the internal flow path 2R. Note that, in this state in which the fluid control valve 32 is closed, fluid is leaking out on the downstream side of the fluid control valve 32, and fluid is accumulating on the upstream side of the fluid control valve 32.

$$S = 1 - \frac{Q 1}{Q 2} \qquad [ Equation 1 ]$$

Here, S is the diagnostic parameter, Q1 is the first flow rate, and Q2 is the second flow rate. Note that it is necessary that the internal volume, which is one of the parameters constituting the second flow rate Q2, be determined before the fluid control apparatus 100 is used. Because of this, when the fluid control apparatus 100 is manufactured, the internal volume is measured so that the diagnostic parameter becomes 0.

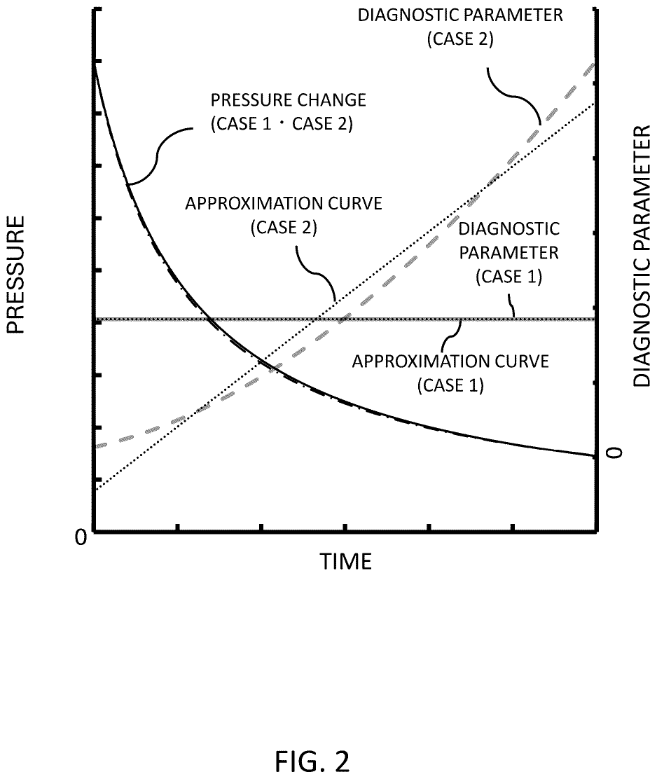

In the present embodiment, the diagnostic parameter calculation unit 432 calculates the diagnostic parameter over a predetermined period of time. More specifically, as shown in FIG. 2, the diagnostic parameter calculation unit 432 calculates the diagnostic parameter over a period of time from when the fluid control valve 32 was closed until the upstream-side pressure P1 drops and converges to a predetermined value.

The diagnostic unit 433 diagnoses an abnormality in the fluid resistor 33 based on the diagnostic parameters, and/or modifies a correction coefficient used in the flow rate calculation by the first flow rate calculation unit 41. In the present embodiment, the diagnostic unit 433 diagnoses an abnormality in the fluid resistor 33 and/or modifies the correction coefficient used in the flow rate calculation by the first flow rate calculation unit 41. This diagnosis and/or modification are performed based on either (i) the value of a diagnostic parameter at any point during a predetermined period after the fluid control valve 32 is closed, or (ii) the change over time in the diagnostic parameter. More specifically, the diagnostic unit 433 calculates an approximation curve that represents the change over time in the diagnostic parameter during the predetermined period. Based on the value of the diagnostic parameter and/or the approximation curve, the diagnostic unit 433 diagnoses an abnormality in the fluid resistor 33 and/or modifies the correction coefficient used in the flow rate calculation by the first flow rate calculation unit 41. Here, examples of the value of the diagnostic parameter include: (a) the value itself at the time during a predetermined period after the fluid control valve 32 is closed; (b) a value obtained by averaging multiple points of the ratio between the first flow rate Q1 and the second flow rate Q2 after the fluid control valve 32 has been closed; or (c) the intercept value of the approximation curve of the diagnostic parameter, among others.

More specifically, in a case in which a diagnostic parameter is constant within a predetermined range that includes zero during a predetermined period, the diagnostic unit 433 diagnoses that the fluid resistor 33 is normal. As shown in FIG. 2, in a case in which the diagnostic parameter is outside the predetermined range that includes zero during a predetermined period and, in addition, a gradient of the approximation curve of the diagnostic parameter is within a predetermined range, then the diagnostic unit 433 diagnoses that there is an abnormality in the fluid resistor 33. Note that an example of the gradient of the approximation curve of the diagnostic parameter being within the predetermined range includes a case in which the gradient of the approximation curve is zero or substantially zero.

In a case in which the diagnostic unit 433 determines that there is an abnormality in the fluid resistor 33, then if the value of the diagnostic parameter is a positive value for a predetermined period, the diagnostic unit 433 is able to determine that this abnormality in the fluid resistor 33 is a leak in the fluid resistor 33. If the value of the diagnostic parameter is a negative value for the predetermined period, then the diagnostic unit 433 is able to determine that the abnormality of the fluid resistor 33 is a blockage in the fluid resistor 33.

FIG. 2 shows changes in pressure, changes over time in diagnostic parameters, and approximation curves in a case in which there is an abnormality in the fluid resistor 33 (Case 1), and in a case in which there is an abnormality in the fluid control device 3 that is not in the fluid resistor (Case 2). As shown in FIG. 2, on and after a point at which the fluid control valve 32 is closed, the change in pressure in Case 1 is almost the same as the change in pressure in Case 2 (shown by a dash-dot line in FIG. 2). Therefore, it is not possible to diagnose which abnormality is present in the fluid control apparatus 100 based only on the changes in pressure in Case 1 and Case 2.

Therefore, by calculating the diagnostic parameters and the approximation curve, it is possible to diagnose whether the abnormality in Case 1 and the abnormality in Case 2 are due to an abnormality in the fluid resistor 33 or due to an abnormality in the fluid control device 3 that is not in the fluid resistor 33. In FIG. 2, each diagnostic parameter is shown by a solid lines, and an approximation curve of each diagnostic parameter is shown by a dotted line. More specifically, in Case 1, the diagnostic parameter at the time when the fluid control valve 32 is closed is outside a predetermined range that includes zero, and the gradient of the approximation curve of the diagnostic parameter for a predetermined period is within the predetermined range. In this case, the abnormality in Case 1 can be diagnosed as an abnormality in the fluid resistor 33.

In contrast, in Case 2, the diagnostic parameter at the time when the fluid control valve 32 is closed is within a predetermined range that includes zero, and the gradient of the approximation curve of the diagnostic parameter for a predetermined period is outside the predetermined range. In this case, the abnormality in Case 2 can be diagnosed as an abnormality in the fluid control device 3 that is not in the fluid resistor 33, while the fluid resistor 33 is normal.

Note that, in a case in which the diagnostic parameter at the time when the fluid control valve 32 is closed is outside a predetermined range that includes zero, and the gradient of the approximation curve of the diagnostic parameter for a predetermined period is also outside the predetermined range, then it can be diagnosed that there is an abnormality in the fluid control device 3 other than in the fluid resistor 33 in addition to the abnormality in the fluid resistor 33. Moreover, in a case in which the diagnostic parameter at the time when the fluid control valve 32 is closed is within a predetermined range that includes zero, and the gradient of the approximation curve of the diagnostic parameter for a predetermined period is also within the predetermined range, then it can be diagnosed that both the fluid resistor 33 and the fluid control device 3 other than the fluid resistor 33 are normal.

In the present embodiment, in a case in which the diagnostic unit 433 diagnoses an abnormality in the fluid resistor 33, then the diagnostic unit 433 is able to modify the correction coefficient used in the flow rate calculation performed by the first flow rate calculation unit 41. In the present embodiment, the correction coefficient is modified by multiplying a value obtained from the first flow rate Q1 and the second flow rate Q2 by an initial correction coefficient showing a ratio between a flow rate of a reference device and a flow rate of a comparator. In the present embodiment, the value obtained from the first flow rate Q1 and the second flow rate Q2 is a ratio between the first flow rate Q1 and the second flow rate Q2.

A method of calculating and modifying the correction coefficient will now be described. Firstly, in an initial state, for example, such as when the fluid control apparatus 100 is shipped or the like, the initial correction coefficient is calculated as a result of the fluid control device 3 calculating a ratio between the flow rate calculated by the calibrated reference device and the flow rate calculated by the fluid control apparatus 100.

Next, in a first diagnosis, the ratio between the first flow rate Q1 and the second flow rate Q2 is calculated, and the correction coefficient is modified by multiplying this ratio by the initial correction coefficient. After the first diagnosis is completed, the first flow rate calculation unit 41 calculates the flow rate while using the product obtained when the initial correction coefficient was multiplied by the ratio between the first flow rate Q1 and the second flow rate Q2 as the correction coefficient.

Next, in a second diagnosis, the ratio between the first flow rate Q1 and the second flow rate Q2 is calculated, and the correction coefficient is modified by multiplying the ratio by the correction coefficient. As a result, the correction coefficient becomes the product of the initial correction coefficient, the ratio calculated in the first diagnosis, and the ratio calculated in the second diagnosis. After the second diagnosis is completed, the first flow rate calculation unit 41 calculates the flow rate using the correction coefficient modified in the second diagnosis.

In a third and subsequent diagnoses, the ratio between the first flow rate Q1 and the second flow rate Q2 is calculated in the same manner as in the second diagnosis, and the correction coefficient is then modified by multiplying this ratio by the correction coefficient modified in the previous diagnosis.

Here, it is also possible for the ratio between the first flow rate Q1 and the second flow rate Q2 that is used when modifying the correction coefficient to be changed in accordance with the gradient of the approximation curve of the diagnostic parameter. For example, in a case in which the gradient of the approximation curve of the diagnostic parameter is outside a predetermined range, the ratio between the first flow rate Q1 and the second flow rate Q2 that is used when modifying the correction coefficient may be the first flow rate Q1 and the second flow rate Q2 at the time when the fluid control valve 32 was closed, or after a predetermined period has elapsed since the time when the fluid control valve 32 was closed, or may be a value obtained by subtracting the intercept value of the approximation curve of the diagnostic parameter from 1. In contrast, in a case in which the gradient of the approximation curve of the diagnostic parameter is within the predetermined range, the ratio between the first flow rate Q1 and the second flow rate Q2 that is used when modifying the correction coefficient may be an average value of a plurality of points of the ratio between the first flow rate Q1 and the second flow rate Q2 after the time when fluid control valve 32 was closed, or may be a value obtained by subtracting the intercept value of the approximation curve of the diagnostic parameter from 1.

Next, the respective components that diagnose abnormalities in the fluid control valve 32 and/or the respective pressure sensors 31a and 31b from among the components forming the diagnostic mechanism 43 will be described.

The valve leak pressure change model creation unit 434 creates a valve leak pressure change model that shows pressure changes that are caused by valve leaks in the fluid control valve 32. A valve leak pressure change model is a model that is able to diagnose an abnormality in the fluid control valve 32 in a case in which a pressure matches the pressures detected by the respective pressure sensors 31a and 31b.

In order to create a valve leak pressure change model, the valve leak pressure change model creation unit 434 first acquires the upstream-side pressure P1 detected by the upstream-side pressure sensor 31a over a predetermined period, for example, from 0 to 3 seconds. Next, the valve leak pressure change model creation unit 434 creates a valve leak pressure change model by fitting Equation 3, which is obtained by solving a differential equation expressed by Equation 2 (see below), to the upstream-side pressure P1 detected by the upstream-side pressure sensor 31a. Note that it is also possible for the valve leak pressure change model creation unit 434 to create a valve leak pressure change model by fitting Equation 3 to the downstream-side pressure P2 detected by the downstream-side pressure sensor 31b.

$$\frac{d P}{d t} = - k {P}^{2} + {c}_{o ν} \qquad [ Equation 2 ]$$

In Equation 2, P is pressure, and k and cₒᵥ are predetermined coefficients. In the case of a valve leak, because the rate of change of the upstream-side pressure P1 has shifted compared to normal conditions, in Equation 2, an amount of shift in the rate of change of the pressure is designated as cₒᵥ, the downstream-side pressure P2 is assumed to be 0, and the change over time in the upstream-side pressure P1 is assumed as a model.

$$P = \frac{1}{b} ( 1 + \frac{2}{a \cdot exp ( 2 b \cdot {c}_{o ν} \cdot t ) - 1} ) \qquad [ Equation 3 ]$$

In Equation 3, P is pressure, t is time, and a, b, and cₒᵥ are coefficients obtained by fitting Equation 3 to the upstream-side pressure P1 detected by the upstream-side pressure sensor 31a.

The valve leak difference calculation unit 435 calculates a valve leak difference, which is a difference between the valve leak pressure change model and the upstream-side pressure P1 detected by the upstream-side pressure sensor 31a. Note that it is also possible for the valve leak difference calculation unit 435 to calculate the valve leak difference as the difference between the valve leak pressure change model and the downstream-side pressure P2 detected by the downstream-side pressure sensor 31b.

In order to calculate the valve leak difference, the valve leak difference calculation unit 435 first acquires the valve leak pressure change model from the valve leak pressure change model creation unit 434, and acquires the upstream-side pressure P1 from the upstream-side pressure sensor 31a. Next, the valve leak difference calculation unit 435 calculates the difference between the valve leak pressure change model and the upstream-side pressure P1, and sets this as the valve leak difference.

The sensor shift pressure change model creation unit 436 creates a sensor shift pressure change model that shows a pressure change that is caused by a sensor shift of the upstream-side pressure sensor 31a or the downstream-side pressure sensor 31b. The sensor shift pressure change model is a model that can diagnose an abnormality in the respective pressure sensors 31a and 31b in a case in which a pressure change matches the pressure detected by the respective pressure sensors 31a and 31b.

In order to create a sensor shift pressure change model, the sensor shift pressure change model creation unit 436 first acquires the upstream-side pressure P1 detected by the upstream-side pressure sensor 31a over a predetermined period, for example, from 0 to 3 seconds. Next, the sensor shift pressure change model creation unit 436 creates the sensor shift pressure change model by fitting Equation 5, which is obtained by solving a differential equation expressed by Equation 4 (see below), to the upstream-side pressure P1 detected by the upstream-side pressure sensor 31a. Note that it is also possible for the sensor shift pressure change model creation unit 436 to create a sensor shift pressure change model by fitting Equation 5 to the downstream-side pressure P2 detected by the downstream-side pressure sensor 31b.

$$\frac{d P}{d t} = - k {P}^{2} \qquad [ Equation 4 ]$$

In Equation 4, P is pressure and k is a predetermined coefficient.

$$P = \frac{A}{t - {t}_{0}} + B \qquad [ Equation 5 ]$$

In Equation 5, P is pressure, t is time, and A, B, and to are coefficients obtained by fitting Equation 5 to the upstream-side pressure P1 detected by the upstream-side pressure sensor 31a.

Here, in the case of a sensor shift, there is simply an overall shift in the upstream-side pressure P1, and because the pressure rate of change in the upstream-side pressure P1 is approximately the same as in a normal state, the sensor shift pressure change model is expressed by Equation 4, and the shift amount is expressed by B, which is an integral constant of Equation 5.

The sensor shift difference calculation unit 437 calculates the sensor shift difference, which is the difference between the sensor shift pressure change model and the upstream-side pressure P1 detected by the upstream-side pressure sensor 31a. The sensor shift difference enables an abnormality in the fluid control valve 32 to be diagnosed in a shorter time than when using the sensor shift pressure change model. Note that it is also possible for the sensor shift difference calculation unit 437 to use a difference between the sensor shift pressure change model and the downstream-side pressure P2 detected by the downstream-side pressure sensor 31b as the sensor shift difference.

In order to calculate a sensor shift difference, the sensor shift difference calculation unit 437 first acquires the sensor shift pressure change model from the sensor shift pressure change model creation unit 436, and then acquires the upstream-side pressure P1 from the upstream-side pressure sensor 31a. Next, the sensor shift difference calculation unit 437 calculates the difference between the sensor shift pressure change model and the upstream-side pressure P1, and sets this as the sensor shift difference.

The diagnostic unit 433 diagnoses abnormalities in the fluid control valve 32 and/or the respective pressure sensors 31a and 31b after having diagnosed abnormalities in the fluid resistor 33, and/or after having modified the correction coefficient.

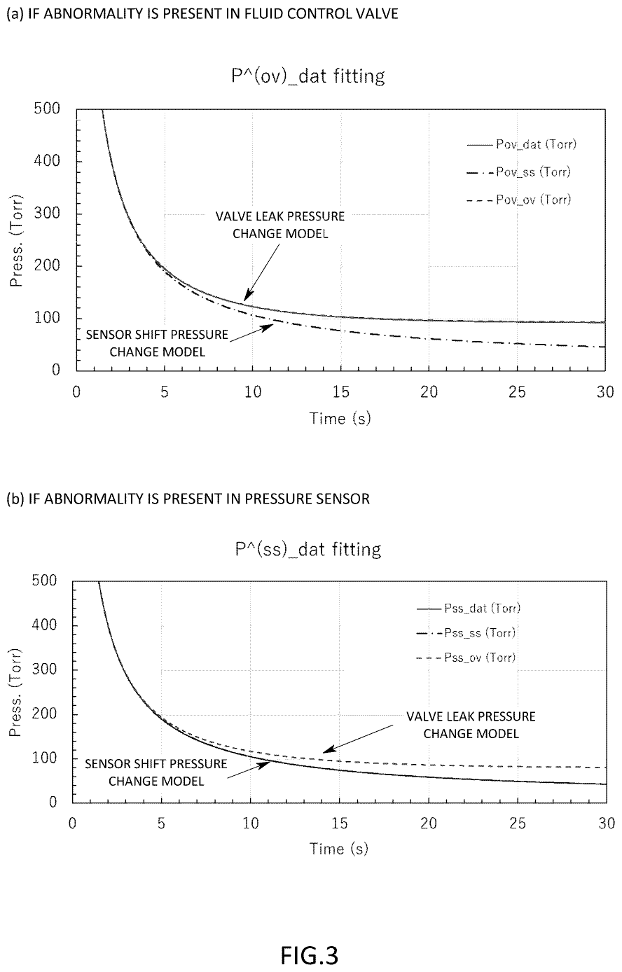

Here, as is shown in FIG. 3 (a), if the pressure change obtained from the valve leak pressure change model matches the change over time in the upstream-side pressure P1 detected by the upstream pressure sensor 31a, then the diagnostic unit 433 is able to diagnose an abnormality in the fluid control valve 32. More specifically, as is shown in FIG. 3 (a), if the pressure change obtained from the valve leak pressure change model matches the change over time in the upstream-side pressure P1 over a predetermined period of time, and the pressure change obtained from the sensor shift pressure change model progressively deviates over time from the upstream-side pressure P1, then the diagnostic unit 433 is able to diagnose an abnormality in the fluid control valve 32.

On the other hand, as shown in FIG. 3 (b), if the pressure change obtained from the sensor shift pressure change model matches the change over time in the upstream-side pressure P1 detected by the upstream-side pressure sensor 31a, then the diagnostic unit 433 is able to diagnose an abnormality in the respective pressure sensors 31a and 31b. More specifically, as shown in FIG. 3 (b), if the pressure change obtained from the sensor shift pressure change model matches the change over time in the upstream-side pressure P1 over a predetermined period of time, and the valve leak pressure change model progressively deviates over time from the upstream-side pressure P1, then the diagnostic unit 433 is able to diagnose an abnormality in the respective pressure sensors 31a and 31b.

It should also be noted that, compared to a case in which the pressure change obtained from the valve leak pressure change model is compared to the pressure change obtained from the sensor shift pressure change model, an abnormality can be diagnosed in a shorter time by comparing the valve leak difference to the sensor shift difference. For this reason, in the present embodiment, after diagnosing an abnormality in the fluid resistor 33 and/or after modifying the correction coefficient, the diagnostic unit 433 diagnoses an abnormality in the fluid control valve 32 and/or an abnormality in the respective pressure sensors 31a and 31b by comparing the valve leak difference to the sensor shift difference. More specifically, the diagnostic unit 433 diagnoses that an abnormality has occurred in the device corresponding to the smaller difference out of the valve leak difference and the sensor shift difference.

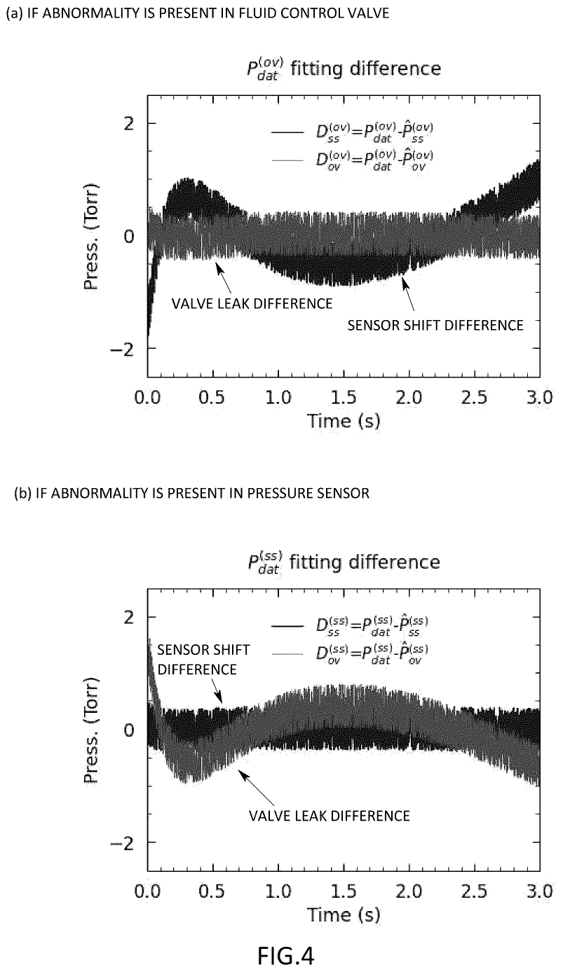

More specifically, the diagnostic unit 433 acquires the valve leak difference and the sensor shift difference for a predetermined period. Next, as shown in FIG. 4 (a), in a case in which the valve leak difference is smaller than the sensor shift difference, the diagnostic unit 433 diagnoses an abnormality in the fluid control valve 32. On the other hand, as shown in FIG. 4 (b), in a case in which the sensor shift difference is smaller than the valve leak difference, the diagnostic unit 433 diagnoses an abnormality in the upstream-side pressure sensor 31a.

Furthermore, in a case in which the diagnostic unit 433 diagnoses that there is an abnormality in the upstream-side pressure sensor 31a, the diagnostic unit 433 determines the sensor shift amount of the upstream-side pressure sensor 31a from the sensor shift pressure change model. The sensor shift amount referred to here is an amount that shows a deviation in the upstream-side pressure sensor 31a from the time of calibration, and more specifically, is a value of the steady-state term of the sensor shift pressure change model (i.e., a value represented by B in Equation 5).

Next, the diagnostic unit 433 outputs the sensor shift amount to the first flow rate calculation unit 41. The first flow rate calculation unit 41 then calculates the first flow rate Q1 by adding the sensor shift amount to the differential pressure ΔP between the upstream-side pressure P1 and the downstream-side pressure P2.

### [Diagnostic Method for a Fluid Control Apparatus]

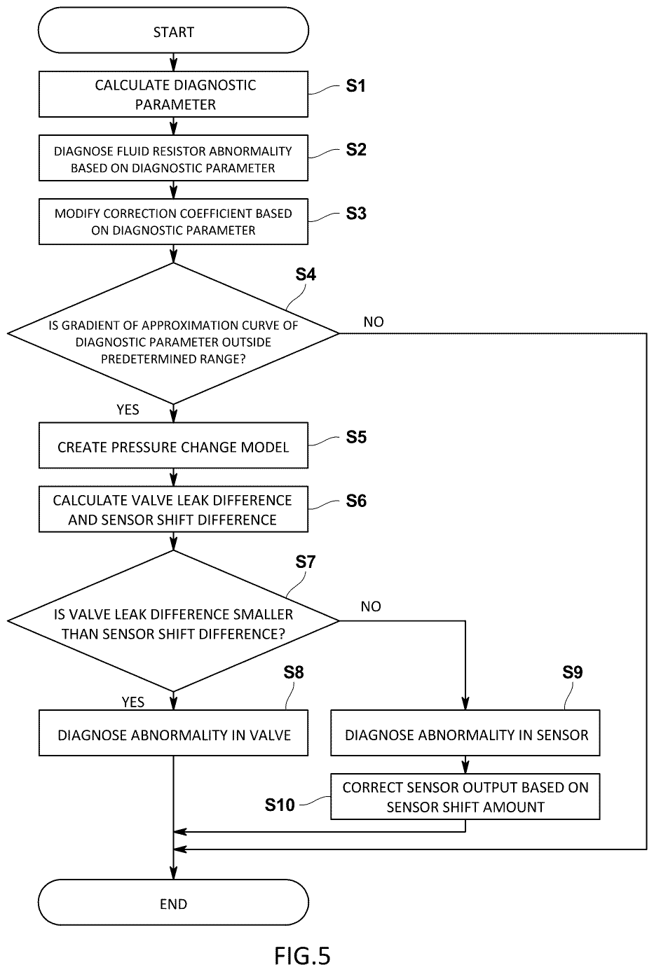

Next, a diagnostic method of the fluid control apparatus 100 of the present embodiment will be described with reference to FIG. 5.

Firstly, in a state in which the fluid control valve 32 has been closed, the first flow rate calculation unit 41 calculates the first flow rate Q1, and the second flow rate calculation unit 431 calculates the second flow rate Q2. Next, the diagnostic parameter calculation unit 432 calculates the diagnostic parameters based on the first flow rate Q1 and the second flow rate Q2 (S1). Note that the diagnostic parameter calculation unit 432 calculates the diagnostic parameters over a predetermined period.

Next, the diagnostic unit 433 diagnoses an abnormality in the fluid resistor 33 based on the diagnostic parameters (S2). More specifically, the diagnostic unit 433 calculates an approximation curve of the diagnostic parameters for a predetermined period, and diagnoses the presence or absence of an abnormality in the fluid resistor 33 and/or the type of abnormality in the fluid resistor 33 based on the approximation curve.

Next, in a case in which there is an abnormality in the fluid resistor 33, the diagnostic unit 433 modifies the correction coefficient used in the flow rate calculation by the first flow rate calculation unit 41 based on the diagnostic parameters (S3). Note that in a case in which there is no abnormality in the fluid resistor 33, it is not necessary for the diagnostic unit 433 to modify the correction coefficient used in the flow rate calculation by the first flow rate calculation unit 41. Moreover, in a case in which, for example, the fluid resistor 33 is replaced, even if there is an abnormality in the fluid resistor 33, the diagnostic unit 433 does not need to modify the correction coefficient.

Next, the diagnostic unit 433 diagnoses whether or not there is an abnormality in the fluid control valve 32 and/or in the respective pressure sensors 31a and 31b based on the gradient of the approximation curve of the diagnostic parameter over a predetermined period (S4). In a case in which the gradient of the approximation curve of the diagnostic parameter is within a predetermined range, the diagnostic unit 433 ends the diagnosis of the fluid control apparatus 100. Note that the next flow may be performed regardless of whether or not the gradient of the approximation curve is within the predetermined range.

In contrast, in a case in which the gradient of the approximation curve of the diagnostic parameter is outside the predetermined range, the diagnostic unit 433 diagnoses that there is an abnormality in the fluid control valve 32 and/or in the respective pressure sensors 31a and 31b. Next, the valve leak pressure change model creating unit 434 acquires the upstream-side pressure P1 and creates a valve leak pressure change model, and the sensor shift pressure change model creating unit 436 acquires the upstream-side pressure P1 and creates a sensor shift pressure change model (S5).

Once the valve leak pressure change model has been created, the valve leak difference calculation unit 435 calculates the valve leak difference based on the valve leak pressure change model and the upstream-side pressure P1. In addition, once the sensor shift pressure change model has been created, the sensor shift difference calculation unit 437 calculates the sensor shift difference based on the sensor shift pressure change model and the upstream-side pressure P1 (S6).

Next, the diagnostic unit 433 compares the valve leak difference to the sensor shift difference so as to diagnose whether there is an abnormality in the fluid control valve 32, or in the respective pressure sensors 31a and 31b (S7). More specifically, the diagnostic unit 433 compares the magnitude of the valve leak difference to the magnitude of the sensor shift difference in order to diagnose whether there is an abnormality in the fluid control valve 32, or in the respective pressure sensors 31a and 31b.

In a case in which the valve leak difference is smaller than the sensor shift difference, the diagnostic unit 433 diagnoses that there is an abnormality in the fluid control valve 32 (S8). The diagnosing unit 433 then ends the diagnosis of the fluid control apparatus 100.

On the other hand, in a case in which the sensor shift difference is smaller than the valve leak difference, the diagnostic unit 433 diagnoses that there is an abnormality in the respective pressure sensors 31a and 31b (S9).

In a case in which the diagnostic unit 433 diagnoses that there is an abnormality in the respective pressure sensors 31a and 31b, the diagnostic unit 433 determines the sensor shift amount of the upstream-side pressure sensor 31a from the sensor shift pressure change model, and then corrects the upstream-side pressure P1 output by the upstream-side pressure sensor 31a based on this sensor shift amount (S10). The diagnostic unit 433 then ends the diagnosis of the fluid control apparatus 100.

[Effects Obtained from the Present Embodiment]

According to the fluid control apparatus 100 of the present embodiment, it is possible to diagnose an abnormality in the fluid resistor 33 using a diagnostic parameter calculated based on the first flow rate Q1 and the second flow rate Q2, which are two flow rates that flow through the fluid resistor in a state in which the fluid control valve 32 is closed.

Moreover, in a case in which there is an abnormality in the fluid resistor 33, the diagnostic unit 433 is able to modify the correction coefficient used in the flow rate calculation by the first flow rate calculation unit 41 based on diagnostic parameters.

In addition, because the diagnostic unit 433 diagnoses whether there is an abnormality in the fluid control valve 32 or in the respective pressure sensors 31a and 31b by comparing the valve leak difference to the sensor shift difference, the diagnostic unit 433 is able to diagnose whether there is an abnormality in the fluid resistor 33, an abnormality in the fluid control valve 32, or an abnormality in the respective pressure sensors 31a and 31b.

### ADDITIONAL EMBODIMENTS

Note that the present invention is not limited to the above-described embodiment.

In the above-described embodiment, the diagnostic unit 433 diagnoses whether there is an abnormality in the fluid resistor 33, an abnormality in the fluid control valve 32, or an abnormality in each of the pressure sensors 31a and 31b, however, it is also possible for the diagnostic unit 433 to only diagnose whether or not there is an abnormality in the fluid resistor 33 from among the various portions of the fluid control device 3.

In the above-described embodiment, the fluid control valve 32 is provided on the upstream side of the respective pressure sensors 31a and 31b, and the diagnosis unit 433 performs a diagnosis based on a drop in pressure at, and after, the point at which the fluid control valve 32 was closed, however, the present invention is not limited to this. For example, it is also possible for the fluid control valve 32 to be provided on the downstream side of the respective pressure sensors 31a and 31b, and for the diagnostic unit 433 to perform diagnosis based on a rise in pressure at, and after, the point at which the fluid control valve 32 was closed.

In the above-described embodiment, the diagnostic unit 433 diagnoses an abnormality in the fluid resistor 33 based on diagnostic parameters, however, it is also possible for the correction coefficient to be modified without an abnormality in the fluid resistor 33 being diagnosed.

In order to easily diagnose whether there is an abnormality in the fluid control valve 32 or an abnormality in the respective pressure sensors, it is also possible for the diagnostic unit 433 to perform a Fourier transform on each of the valve leak difference and the sensor shift difference, and to diagnose whether there is an abnormality in the fluid control valve 32 or an abnormality in each of the pressure sensors 31a and 31b by comparing the Fourier-transformed valve leak difference and sensor shift difference.

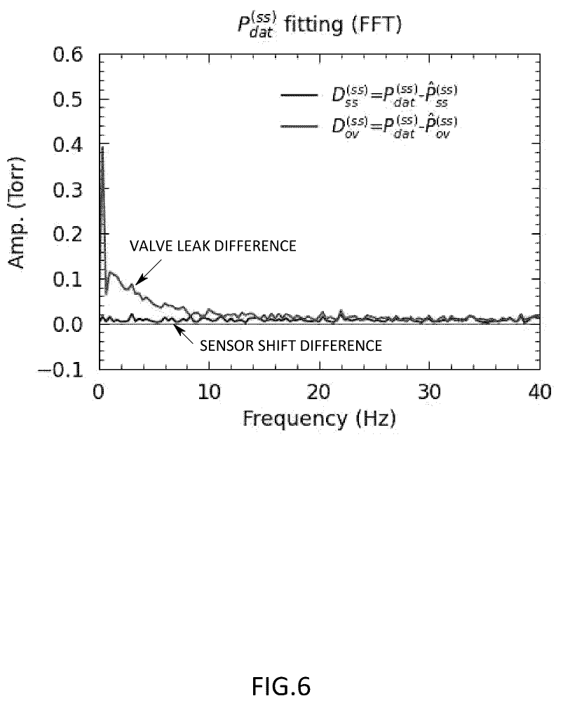

More specifically, the diagnostic unit 433 performs a Fourier transform on each of the valve leak difference and the sensor shift difference. As a result, as shown in FIG. 6, there is a peak at a low frequency, for example, in the vicinity of approximately 3 Hz, in the larger difference, whereas the value after the Fourier transform in the smaller difference is closer to a reference value (for example, 0) compared to the larger difference. Because of this, particularly at low frequencies, the difference between the valve leak difference and the sensor shift difference becomes even greater.

Another aspect of the present invention that enables a diagnosis as to whether there is an abnormality in the fluid control valve or an abnormality in the respective pressure sensors to be made more easily is a structure in which the diagnostic unit 433 diagnoses whether there is an abnormality in the fluid control valve 32 or an abnormality in the respective pressure sensors 31a and 31b by comparing a squared error of the valve leak difference to a squared error of the sensor shift difference.

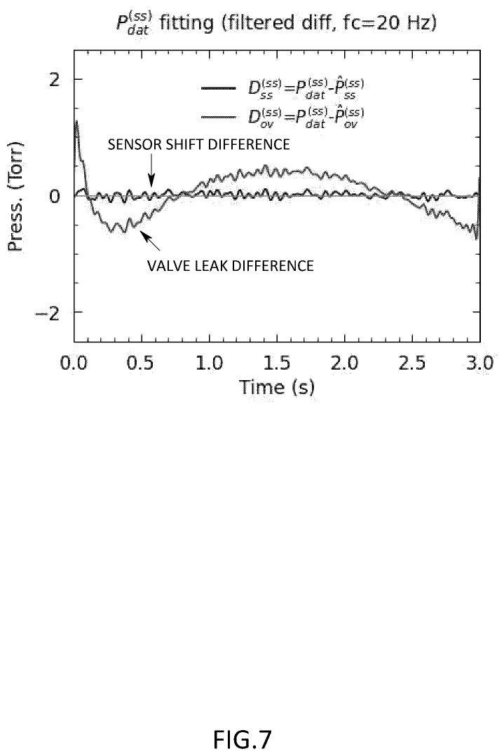

More specifically, the diagnostic unit 433 firstly removes high-frequency noise by applying a low-pass filter to each of the valve leak difference and the sensor shift difference, and then calculates a squared error. As is shown in FIG. 7, by applying a low-pass filter, the distinction between the valve leak difference and the sensor shift difference becomes clear. If a squared error is then calculated for these, the smaller difference is closer to a reference value (e.g., 0), while the larger difference is further away from the reference value. As a result, there is a larger difference between the valve leak difference and the sensor shift difference.

In the above-described embodiment, the diagnostic parameter is a value determined using a ratio between the first flow rate Q1 and the second flow rate Q2, however, it is also possible for the diagnostic parameter to be the actual ratio between the first flow rate Q1 and the second flow rate Q2. In this case, the diagnostic parameter and the correction coefficient have the same value. Note that the ratio between the first flow rate Q1 and the second flow rate Q2 may be expressed with the first flow rate Q1 taken as the numerator and the second flow rate Q2 as the denominator, or may be expressed with the first flow rate Q1 taken as the denominator and the second flow rate Q2 as the numerator.

In the above-described embodiment, it is also possible for the diagnostic unit 433 to output abnormalities in the fluid resistor 33, abnormalities in the fluid control valve 32, and/or abnormalities in the respective pressure sensors 31a and 31b to a display unit such as, for example, a display monitor or the like.

In the present embodiment, the fluid control apparatus 100 is a differential pressure type MFC, however, the present invention is not limited to this and may instead be what is known as a thermal type mass flow controller, or a pressure control device, or another type of fluid control device.

In the above-described embodiment, the diagnostic mechanism 43 is provided with the valve leak pressure change model creation unit 434, the valve leak difference calculation unit 435, the sensor shift pressure change model creation unit 436, and the sensor shift difference calculation unit 437, however, in order to diagnose whether there is an abnormality in the respective pressure sensors or whether there is another type of abnormality, it is sufficient if the diagnostic mechanism 43 is only provided with at least the sensor shift pressure change model creation unit 436 and the sensor shift difference calculation unit 437. Moreover, each model calculates a coefficient by performing fitting, however, it is also possible for a coefficient to be determined using a method other than fitting.

In the present embodiment, the fluid resistor 33 is not limited to being a restrictor, and may instead be, for example, an orifice, a nozzle, a Venturi tube, and/or a capillary or the like. In this case, by applying each model in accordance with the type of fluid resistor 33, it is possible to diagnose whether there is an abnormality in the fluid control valve, or an abnormality in the respective pressure sensors.

Furthermore, it should be understood that the present invention is not limited to the above-described embodiments, and that various modifications and the like may be made thereto insofar as they do not depart from the spirit or scope of the present invention.

According to the present invention, it is possible to diagnose whether or not an abnormality in a fluid control device is an abnormality in a fluid resistor, and to quantitatively determine a correction amount of a correction coefficient used in a flow rate calculation.

### REFERENCE CHARACTER LIST

100 Fluid Control Apparatus
2 Flow Path Block
3 Fluid Control Device
31 Pressure Sensor
31a Upstream-Side Pressure Sensor
31b Downstream-Side Pressure Sensor
32 Fluid Control Valve
33 Fluid Resistor
4 Calculation Control Device
41 First Flow Rate Calculation Unit
42 Valve Control Unit
43 Diagnostic Mechanism
431 Second Flow Rate Calculation Unit
432 Diagnostic Parameter Calculation Unit
433 Diagnostic Unit
434 Valve Leak Pressure Change Model Creation Unit
435 Valve leak Difference Calculation Unit
436 Sensor Shift Pressure Change Model Creation Unit
437 Sensor Shift Difference Calculation Unit
Q1 First Flow Rate
Q2 Second Flow Rate

What is claimed is:

1. A fluid control apparatus comprising:
a fluid resistor that is provided on a flow path;
an upstream-side pressure sensor that detects a pressure on an upstream side of the fluid resistor;
a downstream-side pressure sensor that detects a pressure on a downstream side of the fluid resistor;
a first flow rate calculation unit that calculates a first flow rate flowing through the fluid resistor based on the upstream-side pressure and the downstream-side pressure;
a fluid control valve that is provided on an upstream side of the upstream-side pressure sensor or on a downstream side of the downstream-side pressure sensor;
a valve control unit that controls the fluid control valve based on the first flow rate;
a second flow rate calculation unit that calculates a second flow rate flowing through the fluid resistor based on a change over time in the upstream-side pressure or the downstream-side pressure in a state in which the fluid control valve is closed; and
a diagnostic parameter calculation unit that calculates a diagnostic parameter based on the first flow rate calculated by the first flow rate calculation unit, and on the second flow rate calculated by the second flow rate calculation unit in a state in which the fluid control valve is closed.

2. The fluid control apparatus according to claim 1, further comprising a diagnostic unit that diagnoses an abnormality in the fluid resistor based on the diagnostic parameter, and/or modifies a correction coefficient used in the flow rate calculation by the first flow rate calculation unit.

3. The fluid control apparatus according to claim 2, wherein the diagnostic unit diagnoses an abnormality in the fluid resistor based on a value of the diagnostic parameter at any point during a predetermined period after the fluid control valve was closed, or modifies a correction coefficient used in the flow rate calculation by the first flow rate calculation unit.

4. The fluid control apparatus according to claim 2, wherein the diagnostic unit distinguishes between a blockage and a leak in the fluid resistor based on the value of the diagnostic parameter.

5. The fluid control apparatus according to claim 2, wherein the diagnostic unit diagnoses an abnormality in a fluid device other than the fluid resistor based on a change over time in the diagnostic parameter.

6. The fluid control apparatus according to claim 2, wherein the diagnostic unit diagnoses an abnormality in the fluid control valve and/or an abnormality in each of the pressure sensors after diagnosing an abnormality in the fluid resistor and/or after modifying the correction coefficient.

7. The fluid control apparatus according to claim 1, wherein the diagnostic parameter is a ratio between the first flow rate and the second flow rate, or is a value determined using this ratio.

8. A non-transitory computer-readable medium storing a diagnostic program for a fluid control apparatus that is provided with a fluid resistor that is provided on a flow path, an upstream-side pressure sensor that detects a pressure on an upstream-side of the fluid resistor, a downstream-side pressure sensor that detects a pressure on a downstream side of the fluid resistor, a first flow rate calculation unit that calculates a first flow rate flowing through the fluid resistor based on the upstream-side pressure and the downstream-side pressure, a fluid control valve that is provided on an upstream side of the upstream-side pressure sensor or on a downstream side of the downstream-side pressure sensor, and a valve control unit that controls the fluid control valve based on the first flow rate, the diagnostic program being executable by a computer to cause the computer to:
calculate a second flow rate flowing through the fluid resistor based on a change over time in the upstream-side pressure or the downstream-side pressure in a state in which the fluid control valve is closed; and
calculate a diagnostic parameter based on the first flow rate and the second flow rate.

9. A diagnostic method for a fluid control apparatus that is provided with a fluid resistor that is provided on a flow path, an upstream-side pressure sensor that detects a pressure on an upstream side of the fluid resistor, a downstream-side pressure sensor that detects a pressure on a downstream side of the fluid resistor, a first flow rate calculation unit that calculates a first flow rate flowing through the fluid resistor based on the upstream-side pressure and the downstream-side pressure, a fluid control valve that is provided on an upstream side of the upstream-side pressure sensor or on a downstream side of the downstream-side pressure sensor, and a valve control unit that controls the fluid control valve based on the first flow rate, wherein,
a flow rate flowing through the fluid resistor is calculated based on a change over time in the upstream-side pressure or the downstream-side pressure in a state in which the fluid control valve is closed, and
a diagnostic parameter is calculated based on the first flow rate calculated by the first flow rate calculation unit and on the second flow rate in a state in which the fluid control valve is closed.
